(19) United States
(12) Patent Application Publication
(10) Pub. No.: US 2023/0411597 A1
(43) Pub. Date: Dec. 21, 2023

(54) ELECTRODE FOR LITHIUM SECONDARY BATTERY HAVING ADHESIVE COATING PORTION ADDED THERETO AND METHOD OF MANUFACTURING THE SAME

(71) Applicant: LG ENERGY SOLUTION, LTD., Seoul (KR)

(72) Inventors: Ji Su LEE, Daejeon (KR); Kyung Ryun KA, Daejeon (KR); In Hyouk SUNG, Daejeon (KR)

(73) Assignee: LG ENERGY SOLUTION, LTD., Seoul (KR)

(21) Appl. No.: 18/035,626

(22) PCT Filed: Oct. 13, 2022
(86) PCT No.: PCT/KR2022/015466

§ 371 Date: May 5, 2023

(30) Foreign Application Priority Data
Oct. 13, 2021 (KR) 10-2021-0136064

(51) Int. Cl. H01M 4/36; H01M 10/052; H01M 50/46; H01M 50/403; H01M 10/42; H01M 50/538; H01M 4/04

(52) U.S. Cl. CPC H01M 4/364; H01M 10/052; H01M 50/461; H01M 4/0404; H01M 10/4235; H01M 50/538; H01M 50/403

(57) ABSTRACT

An electrode for a lithium secondary battery may include an electrode mixture layer and an electrode current collector. The electrode mixture layer may be disposed on at least one of a first surface and a second surface of the electrode current collector. The electrode current collector may include an electrode tab extending from an outer periphery of the electrode mixture layer as a portion other than a portion at which the electrode mixture layer is formed. An adhesive coating portion may be disposed at at least a portion of an upper surface of the electrode tab, at at least a portion of an upper surface of the electrode mixture layer, or at both of the foregoing. The electrode may be coupled to a separator via the adhesive coating portion.

### TECHNICAL FIELD

This application claims the benefit of priority to Korean Patent Application No. 2021-0136064 filed on Oct. 13, 2021, the disclosure of which is incorporated herein by reference in its entirety.

The present invention relates to an electrode for a lithium secondary battery having an adhesive coating portion added thereto and a method of manufacturing the same. More particularly, the present invention relates to an electrode for a lithium secondary battery having an adhesive coating portion added thereto such that the electrode is integrally formed with a separator, whereby bending of the separator is prevented, and a method of manufacturing the same.

### BACKGROUND ART

A lithium secondary battery, which can be repeatedly charged and discharged and which has high energy density, has attracted attention as a new energy source that has environmentally friendly characteristics, since the lithium secondary battery not only remarkably reduces the use of fossil fuels but also does not generate by-products as the result of the use of energy.

The lithium secondary battery is manufactured by receiving an electrode assembly including a positive electrode, a negative electrode, and a separator in a battery case together with an electrolyte and sealing the battery case.

An electrode including the positive electrode and the negative electrode may be manufactured by applying an electrode mixture layer to a part of an electrode current collector excluding an electrode tab, and lamination may be performed in the state in which a separator is disposed at an outer surface of the electrode to manufacture an electrode assembly.

If the force of adhesion between the electrode and the separator that are laminated is small, the separator may be separated from the electrode and may bent or rolled during transfer, stacking, and assembly of the electrode assembly.

When the separator is bent, as described above, the positive electrode and the negative electrode come into contact with each other, whereby internal short circuit may occur.

Meanwhile, when the lithium secondary battery is exposed to a high temperature or is abnormally operated, such as internal/external short circuit, overcharging, or overdischarging, the separator shrinks due to heat that is generated, whereby the positive electrode and the negative electrode come into direct contact with each other, and therefore a short circuit possibility is increased.

Hence, various research to prevent internal short circuit, thereby securing safety of a battery cell, has been conducted.

Patent Document 1 discloses a jelly-roll type electrode assembly, wherein a non-coating portion having no positive electrode mixture layer is provided on an outer surface of an electrode foil at the outermost circumferential portion of a positive electrode, an adhesive tape is adhered to a part of the non-coating portion, and the adhesive tape is also adhered to a separator protruding farther upwards and downwards from the positive electrode.

That is, in Patent Document 1, the adhesive tape is attached so as to connect a part of the electrode foil and a part of the separator to each other, whereby the position of the separator is fixed. In the above electrode assembly, a part of a peripheral portion of the separator is fixed to the positive electrode, whereby it is possible to prevent internal short circuit due to shrinkage of the separator during heating.

In Patent Document 1, however, a structure in which the non-coating portion is formed at the outermost side or the innermost side of the jelly-roll type electrode assembly is used, whereby application to a stacked type electrode assembly is difficult. In addition, since the separator cannot be fixed at a temperature equal to or higher than the melting point of the adhesive tape, whereby internal short circuit may occur due to contact between the positive electrode and a negative electrode.

Therefore, there is a need to provide a method capable of preventing bending of a separator that may occur in a stacked type electrode assembly and preventing short circuit even though the separator shrinks.

### PRIOR ART DOCUMENT

(Patent Document 1) Japanese Registered Patent Publication No. 3932096 (2007.03.23)

### DISCLOSURE

### Technical Problem

The present invention has been made in view of the above problems, and it is an object of the present invention to provide an electrode for a lithium secondary battery having an adhesive coating portion added thereto such that the state in which the electrode and a separator is stably maintained during a process of manufacturing the electrode, whereby insulation between a positive electrode and a negative electrode is secured.

It is another object of the present invention to provide a method of manufacturing the electrode for a lithium secondary battery.

### Technical Solution

An electrode for a lithium secondary battery according to the present invention to accomplish the above objects is configured such that an electrode mixture layer is formed on at least one of a first surface and a second surface of an electrode current collector, the electrode current collector includes an electrode tab, which is a non-coating portion extending from an outer periphery of the electrode mixture layer as a part other than a part at which the electrode mixture layer is formed, and an adhesive coating portion is added to an upper surface of the electrode tab and at least a part of an upper surface of the electrode mixture layer.

The adhesive coating portion may be added to at least a part of the upper surface of the electrode tab.

The adhesive coating portion may be added to an upper surface of an outer periphery of one side of the electrode mixture layer adjacent to the electrode tab.

The adhesive coating portion may be added to an upper surface of an outer periphery of the electrode mixture layer opposite an outer periphery of one side of the electrode mixture layer at which the electrode tab is formed.

The adhesive coating portion may be added to an upper surface of the electrode tab and an upper surface of an outer periphery of one side of the electrode mixture layer adjacent to the electrode tab.

The adhesive coating portion may be added to an upper surface of the electrode tab, an upper surface of an outer periphery of one side of the electrode mixture layer adjacent to the electrode tab, and an upper surface of an outer periphery of the electrode mixture layer opposite the outer periphery of the one side of the electrode mixture layer.

The adhesive coating portion may include a non-electric conductive adhesive.

The non-electric conductive adhesive may be made of a polymer material having a glass transition temperature (Tg) of 100° C. or lower.

The adhesive coating portion may be added to at least one of the first surface and the second surface, and the electrode may include a separator attached to the adhesive coating portion on the at least one of the first surface and the second surface to which the adhesive coating portion is added.

The present invention provides a method of manufacturing the electrode for a lithium secondary battery. Specifically, the method includes (a) forming an electrode mixture layer on at least one surface of an electrode current collector, (b) adding an adhesive coating portion to an upper surface of an electrode tab extending from an outer periphery of the electrode mixture layer and at least a part of an upper surface of the electrode mixture layer, (c) disposing a separator on the electrode mixture layer and the adhesive coating portion of step (b), and (d) pressing the separator.

Step (d) may include a heating process.

The adhesive coating portion may be formed on at least one of a positive electrode and a negative electrode.

The present invention provides an electrode assembly including the electrode for a lithium secondary battery, wherein the electrode assembly is a stacked type electrode assembly, a stacked and folded type electrode assembly, a laminated and stacked type electrode assembly, or a jelly-roll type electrode assembly.

In addition, the present invention may provide various combinations of the above solving means.

### Advantageous Effects

As is apparent from the above description, in an electrode for a lithium secondary battery according to the present invention, it is possible to secure the force of adhesion between the electrode and a separator by addition of an adhesive coating portion, whereby it is possible to prevent bending of the separator. Consequently, it is possible to secure insulation between a positive electrode and a negative electrode, and therefore it is possible to improve safety of a lithium secondary battery.

In addition, it is possible to adjust the adhesive force by adjusting the glass transition temperature of an adhesive constituting the adhesive coating portion, the coating area, and temperature and/or time of a heating process.

In addition, it is possible to inhibit shrinkage of the separator even at a high temperature, and therefore it is possible to prevent formation of a contact area between the positive electrode and the negative electrode when a battery cell is exposed to the high temperature.

Meanwhile, when the adhesive coating portion is applied over an electrode mixture layer and an electrode tab, it is possible to prevent generation of lithium precipitates even though an end of an outer periphery of the negative electrode is shorter than an end of an outer periphery of the positive electrode.

### BRIEF DESCRIPTION OF THE DRAWINGS

FIG. 1 is a plan view and a partial enlarged sectional view of an electrode according to a first embodiment.

FIG. 2 is a plan view and a partial enlarged sectional view of an electrode according to a second embodiment.

FIG. 3 is a plan view and a partial enlarged sectional view of an electrode according to a third embodiment.

FIG. 4 is a plan view and a partial enlarged sectional view of an electrode according to a fourth embodiment.

FIG. 5 is a plan view and a partial enlarged sectional view of an electrode according to a fifth embodiment.

FIG. 6 is a plan view and a partial enlarged sectional view of an electrode according to a sixth embodiment.

FIGS. 7(a) and 7(b) are partial perspective views of electrodes according to a seventh embodiment and an eighth embodiment, respectively.

FIGS. 8(a) to 8(e) are views showing a process of manufacturing an electrode for a lithium secondary battery.

### EMBODIMENTS OF THE DISCLOSURE

Now, preferred embodiments of the present invention will be described in detail with reference to the accompanying drawings such that the preferred embodiments of the present invention can be easily implemented by a person having ordinary skill in the art to which the present invention pertains. In describing the principle of operation of the preferred embodiments of the present invention in detail, however, a detailed description of known functions and configurations incorporated herein will be omitted when the same may obscure the subject matter of the present invention.

In addition, the same reference numbers will be used throughout the drawings to refer to parts that perform similar functions or operations. In the case in which one part is said to be connected to another part throughout the specification, not only may the one part be directly connected to the other part, but also, the one part may be indirectly connected to the other part via a further part. In addition, that a certain element is included does not mean that other elements are excluded, but means that such elements may be further included unless mentioned otherwise.

In addition, a description to embody elements through limitation or addition may be applied to all inventions, unless particularly restricted, and does not limit a specific invention.

Also, in the description of the invention and the claims of the present application, singular forms are intended to include plural forms unless mentioned otherwise.

Also, in the description of the invention and the claims of the present application, “or” includes “and” unless mentioned otherwise. Therefore, “including A or B” means three cases, namely, the case including A, the case including B, and the case including A and B.

Hereinafter, embodiments of the present invention will be described in detail with reference to the accompanying drawings.

An electrode according to the present invention may be configured to have a structure in which an electrode tab protrudes from an outer periphery of one side of an electrode current collector having a rectangular shape when viewed in plan and in which an electrode mixture layer is formed on the electrode current collector. In addition, the electrode according to the present invention may be configured to have a structure in which an electrode tab may be attached to a long sheet type electrode current collector and in which an electrode mixture layer is formed on the electrode current collector.

The electrode mixture layer is formed on at least one of a first surface, which is an upper surface, and a second surface, which is a lower surface, of the electrode current collector.

The electrode current collector includes an electrode tab, which is a non-coating portion extending from an outer periphery of the electrode mixture layer as a part other than a part at which the electrode mixture layer is formed, and an adhesive coating portion is added to an upper surface of the electrode tab and at least a part of an upper surface of the electrode mixture layer. The non-coating portion means a part at which the electrode mixture layer is not formed.

The adhesive coating portion is made of a material that allows a separator to be adhered thereto while having an insulation property. Even when the temperature of the adhesive coating portion reaches a temperature at which an adhesive function of the adhesive coating portion is lost and the separator shrinks, therefore, the adhesive coating portion remains added to the electrode, whereby it is possible to prevent contact with another electrode.

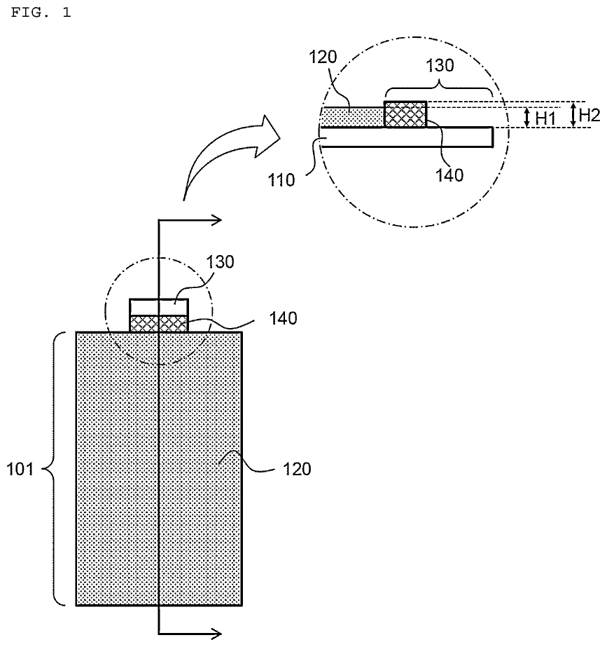

FIG. 1 is a plan view and a partial enlarged sectional view of an electrode according to a first embodiment.

Referring to FIG. 1, an electrode current collector 110 includes an electrode main body 101 having an electrode mixture layer 120 formed thereon and an electrode tab 130, which is a non-coating portion extending from an outer periphery of the electrode mixture layer 120.

An adhesive coating portion 140 is added to a part of an upper surface of the electrode tab 130 at a position adjacent to the electrode mixture layer 120.

The force of adhesion between a separator and the electrode may be increased through the adhesive coating portion 140, whereby the force of coupling between the electrode and the separator may be increased and the electrode and the separator may be integrally coupled to each other.

Internal short circuit may occur between a positive electrode and a negative electrode as follows: internal short circuit may occur due to contact between a positive electrode mixture layer and a negative electrode mixture layer, contact between the positive electrode mixture layer and a negative electrode current collector, contact between a positive electrode current collector and the negative electrode mixture layer, or contact between the positive electrode current collector and the negative electrode current collector. When the positive electrode current collector (positive electrode tab) and the negative electrode mixture layer come into contact with each other, the largest amount of heat is generated.

When the adhesive coating portion 140 is added to the upper surface of the electrode tab, as shown in FIG. 1, it is possible to secure the force of adhesion between the electrode tab and the separator. In addition, even when the temperature of the adhesive coating portion 140 reaches a temperature at which an adhesive function of the adhesive coating portion is lost, it is possible to prevent contact between the positive electrode tab and the negative electrode mixture layer, since the adhesive coating portion 140 is added to an outer surface of the electrode tab.

The electrode tab 130 may be connected to an electrode lead and may extend outwards from a battery case so as to be used as an electrode terminal.

Consequently, the adhesive coating portion 140 is added to a part of the electrode tab 130 adjacent to the electrode mixture layer 120; however, a non-coating portion is exposed from an end of the electrode tab 130 opposite the electrode mixture layer 120 such that the end of the electrode tab is coupled to the electrode lead.

The thickness H2 of the adhesive coating portion 140 may be equal to or greater than the thickness H1 of the electrode mixture layer 120 such that the adhesive coating portion and the separator can be easily attached to each other.

Alternatively, when the shape of a pressing roll configured to perform lamination is changed or a pressing method is adjusted, lamination may be possible even though the thickness H2 of the adhesive coating portion is less than the thickness H1 of the electrode mixture layer.

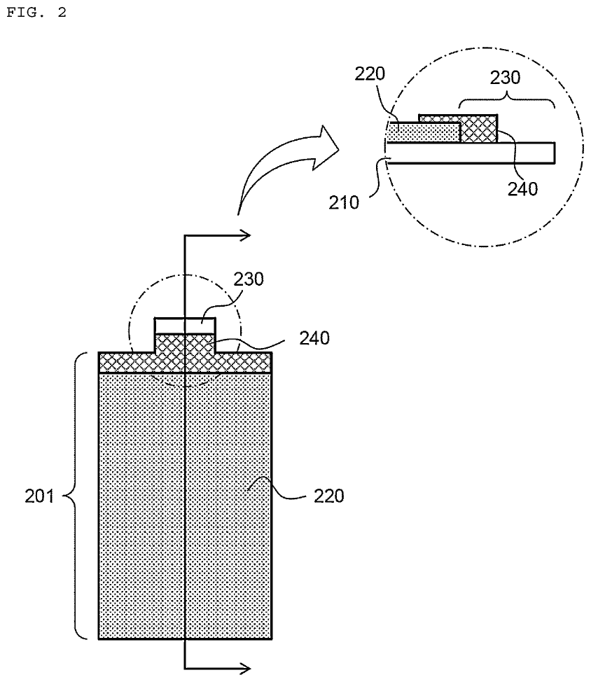

FIG. 2 is a plan view and a partial enlarged sectional view of an electrode according to a second embodiment.

Referring to FIG. 2, an electrode current collector 210 includes an electrode main body 201 having an electrode mixture layer 220 formed thereon and an electrode tab 230, which is a non-coating portion extending from an outer periphery of the electrode mixture layer 220.

The electrode tab 230 is formed as the result of a part of an outer periphery of one side of the electrode main body 201 further extending outwards, and is coupled to an electrode lead.

An adhesive coating portion 240 is added to an upper surface of the electrode tab 230 and an upper surface of an outer periphery of one side of the electrode mixture layer 220 adjacent to the electrode tab 230. When the adhesive coating portion is added along the outer periphery of one side of the electrode mixture layer, as described above, it is possible to more widely secure the adhesive interface between a separator and the adhesive coating portion.

The adhesive coating portion 240 is added to only the remaining part of the electrode tab excluding an outer end thereof, and the adhesive coating portion 240 is not applied to the end of the electrode tab 230 that functions as the electrode tab. The end of the electrode tab constitutes a weld portion for coupling with the electrode lead.

Meanwhile, when an electrode assembly is manufactured, the area of a negative electrode is generally formed so as to be greater than the area of a positive electrode. When the positive electrode and the negative electrode are misaligned with each other during a lamination process, lamination may be performed in the state in which the negative electrode is not present on the surface opposite the positive electrode.

In this case, an end region of the negative electrode may be overcharged, whereby lithium precipitation may occur, and therefore lithium dendrites may be formed. The lithium dendrites may grow toward the positive electrode through the separator, whereby internal short circuit may occur. In the present invention, as shown in FIG. 2, the adhesive coating portion is formed on the positive electrode so as to further extend in a direction from the outer periphery of the positive electrode mixture layer to a positive electrode tab. In this case, it is possible to prevent the occurrence of short circuit due to contact between lithium dendrites growing toward the positive electrode and the positive electrode tab.

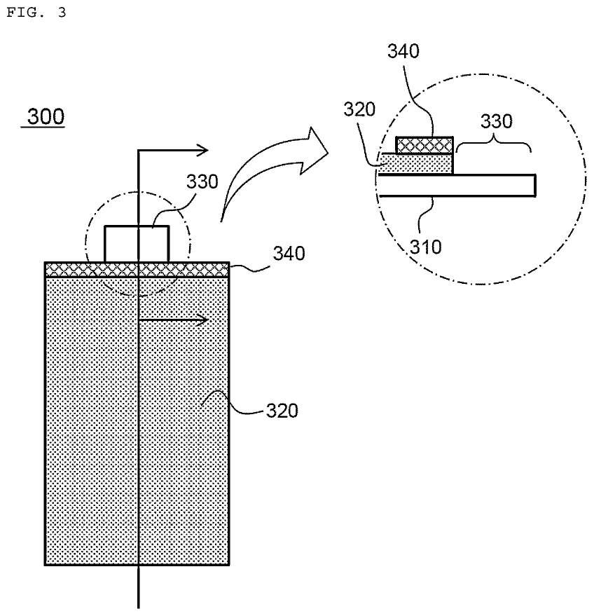

FIG. 3 is a plan view and a partial enlarged sectional view of an electrode according to a third embodiment.

Referring to FIG. 3, the electrode 300 is identical to the electrodes shown in FIGS. 1 and 2 in terms of the structures of an electrode mixture layer 320 formed on an electrode current collector 310 and an electrode tab 330.

An adhesive coating portion 340 is formed on only an upper surface of the electrode mixture layer 320. Specifically, the adhesive coating portion is formed on only an upper surface of an outer periphery of one side of the electrode mixture layer 320 adjacent to the electrode tab 330.

Consequently, a separator and the electrode may be stably coupled to each other via the adhesive coating portion at the outer periphery of one side of the electrode mixture layer adjacent to the electrode tab.

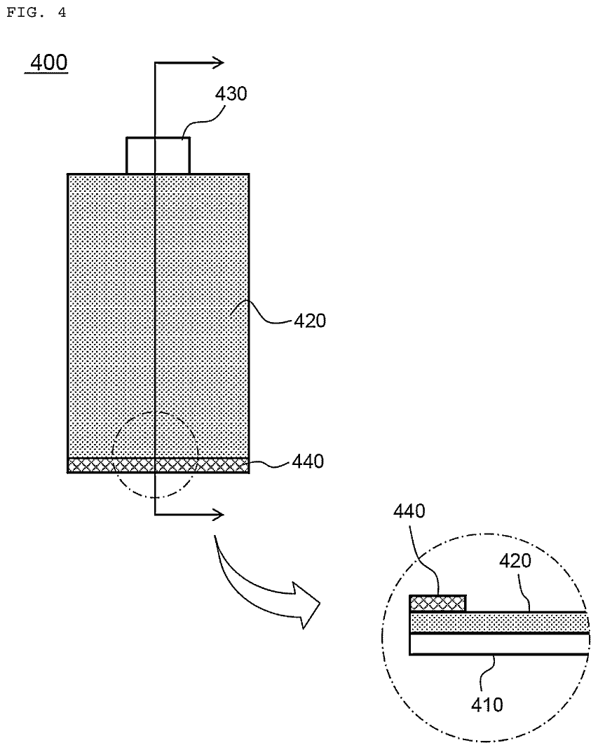

FIG. 4 is a plan view and a partial enlarged sectional view of an electrode according to a fourth embodiment.

Referring to FIG. 4, the electrode 400 is identical to the electrodes shown in FIGS. 1 to 3 in terms of the structures of an electrode mixture layer 420 formed on an electrode current collector 410 and an electrode tab 430.

An adhesive coating portion 440 is formed on an upper surface of an outer periphery of the electrode mixture layer 420 opposite an outer periphery of one side of the electrode mixture layer at which the electrode tab 430 is formed.

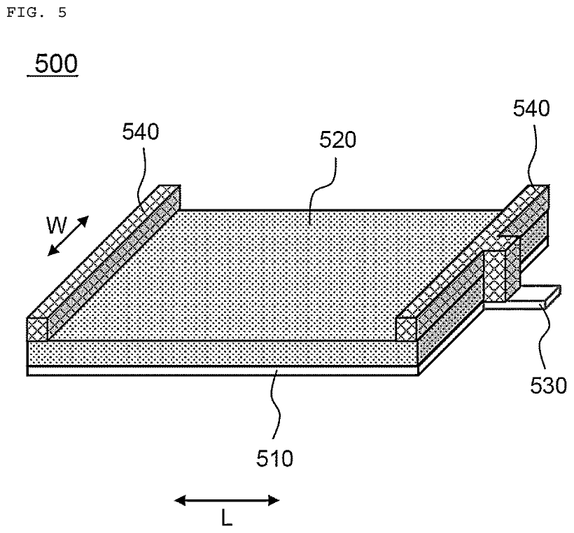

FIG. 5 is a plan view and a partial enlarged sectional view of an electrode according to a fifth embodiment.

Referring to FIG. 5, the electrode 500 is identical to the electrodes shown in FIGS. 1 to 4 in terms of the structures of an electrode mixture layer 520 formed on an electrode current collector 510 and an electrode tab 530.

An adhesive coating portion 540 is formed on an upper surface of the electrode tab 530, an upper surface of an outer periphery of one side of the electrode mixture layer 520 adjacent to the electrode tab 530, and an upper surface of an outer periphery of the electrode mixture layer 520 opposite the outer periphery of the one side of the electrode mixture layer 520.

FIG. 5 shows that the adhesive coating portion 540 of the electrode 500 is formed on outer peripheries of opposite sides of the electrode mixture layer in an overall width direction W thereof. Alternatively, the adhesive coating portion may be formed on outer peripheries of opposite sides of the electrode mixture layer in an overall length direction L thereof. Also, in the present invention, the adhesive coating portion may be formed on the outer peripheries of the opposite sides of the electrode mixture layer in the overall length direction L thereof and an upper surface of the electrode tab.

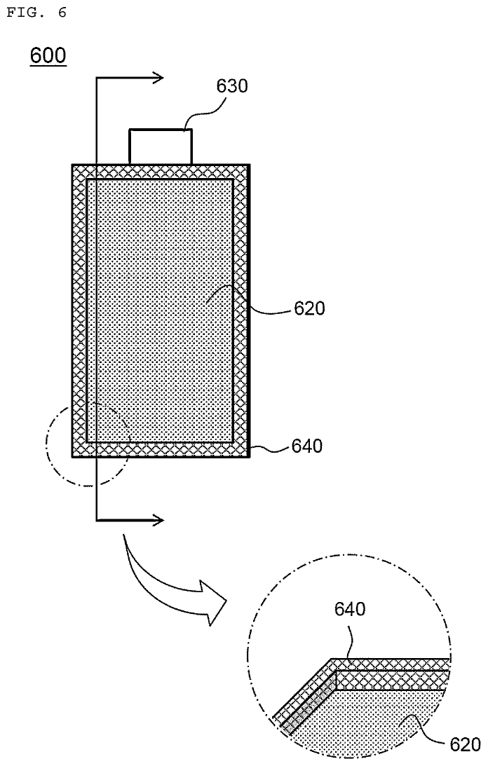

FIG. 6 is a plan view and a partial enlarged sectional view of an electrode according to a sixth embodiment.

Referring to FIG. 6, the electrode 600 is identical to the electrodes shown in FIGS. 1 to 5 in terms of the structures of an electrode mixture layer 620 formed on an electrode current collector and an electrode tab 630.

An adhesive coating portion 640 is formed along the entirety of an outer periphery of an upper surface of the electrode mixture layer 620, which has a rectangular shape when viewed in plan. Additionally, the adhesive coating portion may be formed on the entirety of the outer periphery of the upper surface of the electrode mixture layer and an upper surface of the electrode tab 630.

In the electrode 600 having the adhesive coating portion, formed as described above, added thereto, the adhesive interface between the adhesive coating portion 640 and a separator is widely formed, whereby the separator and the electrode may be stably coupled to each other.

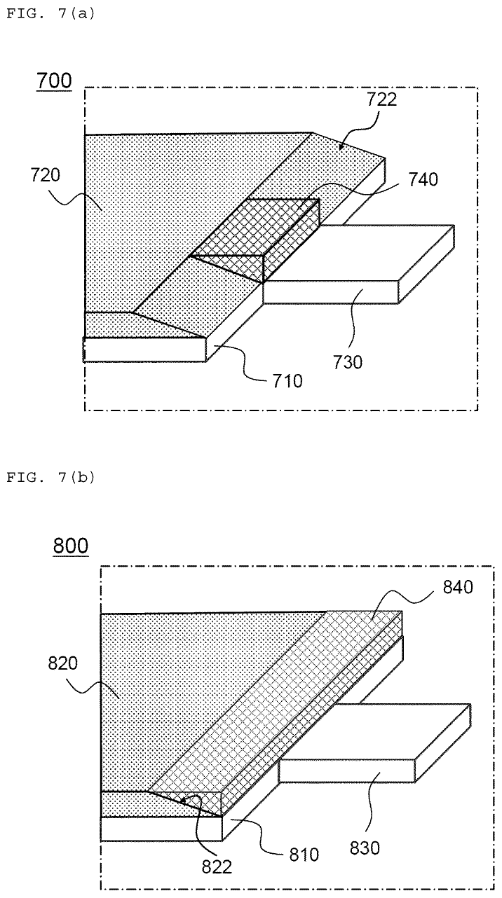

FIGS. 7(a) and 7(b) are partial perspective views of electrodes according to a seventh embodiment and an eighth embodiment, respectively.

Referring to FIG. 7(a), the electrode 700 is an electrode according to a seventh embodiment, and referring to FIG. 7(b), the electrode 800 is an electrode according to an eighth embodiment.

Each of the electrodes shown in FIGS. 7(a) and 7(b) includes an inclined portion 722 or 822 formed at a part of an outer periphery of an electrode mixture layer 720 or 820 to which an electrode tab 730 or 830 is connected, wherein an outer surface of the inclined portion in a thickness direction thereof is inclined. An adhesive coating portion 740 is shown as being applied to only a part of an upper surface of the inclined portion 722 of the electrode mixture layer 720 adjacent to the electrode tab 730. Unlike this, the adhesive coating portion may be added so as to extend up to an upper part of the electrode tab 730.

Consequently, it is possible to secure the force of adhesion between the separator and the electrode through the adhesive coating portion at a region of the electrode adjacent to the electrode tab, at which a largest amount of heat is generated.

The adhesive coating portion 840 of FIG. 7(b) is shown as being applied along an outer periphery of an upper surface of the inclined portion 822 of the electrode mixture layer 820 adjacent to the electrode tab 830. Unlike this, the adhesive coating portion 840 may be added so as to extend up to an upper part of the electrode tab 830.

Consequently, it is possible to secure the force of adhesion between the separator and the electrode through the adhesive coating portion at the outer periphery of the electrode mixture layer 820 adjacent to the electrode tab 830.

The thickness of the adhesive coating portion 740 or 840 added to the inclined portion 722 or 822 is gradually increased toward the outer periphery of the electrode mixture layer 720 or 820, and the maximum thickness of the adhesive coating portion 740 or 840 is formed so as to be equal to or greater than the thickness of the electrode mixture layer 720 or 820. During a process of pressing the electrode and the separator so as to be attached to each other, therefore, the separator and the adhesive coating portion may be attached to each other in tight contact with each other.

Alternatively, the maximum thickness of the adhesive coating portion 740 or 840 may be formed so as to be less than the thickness of the electrode mixture layer 720 or 820. Even in this case, the adhesive coating portion and the separator may be attached to each other through lamination.

In each of the electrodes according to the first to eighth embodiments of the present invention, the adhesive coating portion may be added to at least one of the first surface and the second surface of the electrode current collector, and a separator may be attached to the adhesive coating portion on at least one of the first surface and the second surface of the electrode current collector, to which the adhesive coating portion is added.

The electrode may be a positive electrode and/or a negative electrode, wherein the separator may be attached to a part of an outer surface of the positive electrode to which the adhesive coating portion is added, the separator may be attached to a part of an outer surface of the negative electrode to which the adhesive coating portion is added, or the separator may be attached to the part of the outer surface of each of the positive electrode and the negative electrode to which the adhesive coating portion is added.

As a result, an integrated structure in which the electrode and the separator are coupled to each other via the adhesive coating portion is formed, and therefore it is possible to prevent separation of the separator from the electrode, thereby preventing bending or rolling of the separator.

The adhesive coating portion includes an adhesive.

The adhesive may include a polymer material having a glass transition temperature (Tg) of 100° C. or lower. For example, the adhesive may be polyacrylate, polyacrylic acid, polymethacrylate, polymethyl methacrylate, polyvinyl alcohol, polyvinyl chloride, polyvinylidene fluoride, polyvinylidene fluoride-hexafluoropropylene, polyethylene, polypropylene, polybutadiene, polyisoprene, styrene butadiene rubber, polyvinyl acetate, polyester, polysiloxane, polydimethylsiloxane, polyethylene terephthalate, polyethylene oxide, polypropylene oxide, polyacrylonitrile, polyvinyl acetal, polyvinyl propionate, ethyl cellulose, carboxymethyl cellulose, polyperfluoropropylene, natural rubber, or a derivative or copolymer thereof.

The adhesive coating portion is a part adhered to the separator. In order to secure insulation between different electrodes, the adhesive included in the adhesive coating portion may be a non-electric conductive adhesive.

In the present invention, the kind of the adhesive included in the adhesive coating portion and the composition ratio of the adhesive may be adjusted to adjust the glass transition temperature of the adhesive. In addition, the area of the adhesive coating portion may be adjusted, and time and temperature necessary to attach the separator to the adhesive coating portion may also be adjusted. It is possible to adjust adhesive force of the adhesive coating portion by adjusting the composition, area, pressing time, and pressing temperature of the adhesive coating portion, as described above.

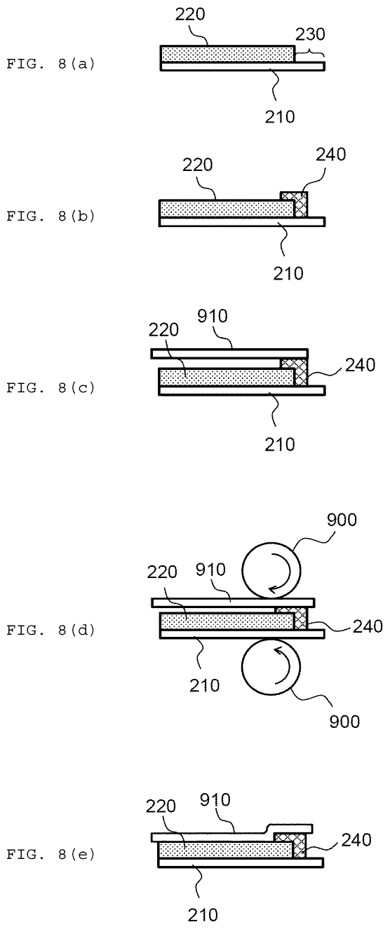

FIGS. 8(a) to 8(e) are views showing a process of manufacturing an electrode for a lithium secondary battery.

An electrode mixture layer 220 is formed on at least one surface of an electrode current collector 210. Unlike what is shown in FIGS. 8(a) to 8(e), however, the electrode mixture layer 220 may be formed on each of opposite surfaces of the electrode current collector 210. In addition, the electrode mixture layer 220 may be formed so as to have a uniform thickness, or the electrode mixture layer may include an inclined portion formed at an outer periphery thereof adjacent to an electrode tab 230 such that an outer surface of the inclined portion in a thickness direction thereof is inclined, as in the electrode mixture layers 720 and 820 shown in FIGS. 7(a) and 7(b).

An adhesive coating portion 240 is added to a part of an upper surface of the electrode tab 230 and an upper surface of an outer periphery of one side of the electrode mixture layer 220 adjacent to the electrode tab 230.

The adhesive coating portion 240 may be added to only the remaining part of the electrode tab excluding an outer end thereof, and the outer end of the electrode tab to which the adhesive coating portion is not added may be coupled to an electrode lead, whereby electrical connection may be achieved.

A separator 910 is disposed above the electrode mixture layer 220 and on the adhesive coating portion 240. A left end of the separator 910 extends farther than the electrode mixture layer 220. A right end of the separator 910 extends to an outer end of the adhesive coating portion 240 or extends farther than the outer end of the adhesive coating portion 240.

In the state in which the electrode and the separator are disposed so as to overlap each other, as described above, the electrode and the separator are pressed using a pair of pressing rolls 900 disposed above and under the electrode and the separator, respectively, such that the electrode and the separator are attached to each other.

The adhesive coating portion includes a non-electric conductive adhesive made of a polymer material having a glass transition temperature (Tg) of 100° C. or lower. Pressing may be performed in the state in which the pressing rolls 900 are heated such that the temperature of the pressing rolls is higher than the glass transition temperature of the non-electric conductive adhesive, whereby it is possible to secure the force of coupling between the adhesive coating portion 240 and the separator 910.

The electrode manufactured using the above method forms an integrated structure together with the separator, and therefore it is possible to prevent separation of the separator from the electrode, thereby preventing bending or rolling of the separator. In addition, it is possible to secure insulation between a positive electrode and a negative electrode.

The electrode manufactured as described above may be used as an electrode for a lithium secondary battery and may constitute a stacked type electrode assembly, a stacked and folded type electrode assembly, a laminated and stacked type electrode assembly, or a jelly-roll type electrode assembly.

In addition, the above electrode may be received in a battery case to constitute a unit battery, and a battery module or a battery pack including the unit battery may be provided.

Those skilled in the art to which the present invention pertains will appreciate that various applications and modifications are possible within the category of the present invention based on the above description.

### DESCRIPTION OF REFERENCE NUMERALS

101, 201: Electrode main bodies
110, 210, 310, 410, 510: Electrode current collectors
120, 220, 320, 420, 520, 620, 720, 820: Electrode mixture layers
130, 230, 330, 430, 530, 630, 730, 830: Electrode tabs
140, 240, 340, 440, 540, 640, 740, 840: Adhesive coating portions
722, 822: Inclined portions
300, 400, 500, 600, 700, 800: Electrodes
900: Pressing roll
910: Separator
H1: Thickness of electrode mixture layer
H2: Thickness of adhesive coating portion
L: Overall length direction
W: Overall width direction

1. An electrode for a lithium secondary battery, the electrode comprising:
an electrode mixture layer; and
an electrode current collector,
wherein:
the electrode mixture layer is disposed on at least one of a first surface and a second surface of the electrode current collector; and
the electrode current collector comprises an electrode tab, which is a non-coating portion extending from an outer periphery of the electrode mixture layer as a portion other than a portion at which the electrode mixture layer is disposed, and
wherein:
an adhesive coating portion is disposed at at least a portion of an upper surface of the electrode tab;
the adhesive coating portion is disposed at at least a portion of an upper surface of the electrode mixture layer; or
the adhesive coating portion is disposed at the at least a portion of the upper surface of the electrode tab and at the at least a portion of the upper surface of the electrode mixture layer.

2. The electrode according to claim 1, wherein the adhesive coating portion is disposed at the at least a portion of the upper surface of the electrode tab.

3. The electrode according to claim 1, wherein the adhesive coating portion is disposed at an upper surface of an outer periphery of one side of the electrode mixture layer adjacent to the electrode tab.

4. The electrode according to claim 1, wherein the adhesive coating portion is disposed at an upper surface of an outer periphery of the electrode mixture layer opposite an outer periphery of one side of the electrode mixture layer at which the electrode tab is disposed.

5. The electrode according to claim 1, wherein the adhesive coating portion is disposed at the upper surface of the electrode tab and an upper surface of an outer periphery of one side of the electrode mixture layer adjacent to the electrode tab.

6. The electrode according to claim 1, wherein the adhesive coating portion is disposed at the upper surface of the electrode tab, an upper surface of an outer periphery of one side of the electrode mixture layer adjacent to the electrode tab, and an upper surface of an outer periphery of the electrode mixture layer opposite the outer periphery of the one side of the electrode mixture layer.

7. The electrode according to claim 1, wherein the adhesive coating portion comprises a non-electric conductive adhesive.

8. The electrode according to claim 7, wherein the non-electric conductive adhesive is made of a polymer material having a glass transition temperature (Tg) of 100° C. or lower.

9. The electrode according to claim 1, wherein:
the adhesive coating portion is disposed at at least one of the first surface and the second surface; and
the electrode comprises a separator attached to the adhesive coating portion on the at least one of the first surface and the second surface at which the adhesive coating portion is disposed.

10. A method of manufacturing the electrode according to claim 1, the method comprising:
forming the electrode mixture layer on at least one surface of the electrode current collector;
adding the adhesive coating portion;
disposing a separator on the electrode mixture layer and the adhesive coating portion; and
pressing the separator,
wherein the adding the adhesive coating portion comprises:
adding the adhesive coating portion to the at least a portion of the upper surface of the electrode tab;
adding the adhesive coating portion to the at least a portion of the upper surface of the electrode mixture layer; or
adding the adhesive coating portion to the at least a portion of the upper surface of the electrode tab and to the at least a portion of the upper surface of the electrode mixture layer.

11. The method according to claim 10, wherein the pressing the separator comprises a heating process.

12. The method according to claim 10, wherein the adhesive coating portion is formed on at least one of a positive electrode and a negative electrode.

13. An electrode assembly comprising the electrode according to claim 1, wherein the electrode assembly is a stacked type electrode assembly, a stacked and folded type electrode assembly, a laminated and stacked type electrode assembly, or a jelly-roll type electrode assembly.
